(19) United States
(12) Patent Application Publication
(10) Pub. No.: US 2024/0321533 A1
(43) Pub. Date: Sep. 26, 2024

(54) MECHANICAL KEYBOARD WITH PRINTED MEMBRANE

(71) Applicant: Logitech Europe S.A., Lausanne (CH)

(72) Inventors: Sebastien Gadelle, Hsinchu City (TW); Feng-Hao Lin, Hsinchu City (TW); Fleming Chao, Hsinchu City (TW); Sonic Lu, Zhubei City (TW)

(21) Appl. No.: 18/188,375

(22) Filed: Mar. 22, 2023

(51) Int. Cl. H01H 13/704; G06F 1/16; H01H 13/14

(52) U.S. Cl. CPC H01H 13/704; G06F 1/1662; H01H 13/14

(57) ABSTRACT

Embodiments of the present invention may encompass electronics assemblies of computer peripheral devices. The assemblies may include an outer top case. The assemblies may include a mechanical support layer disposed on an inner side of the outer top case. The assemblies may include a membrane layer coupled with the mechanical support layer. The membrane layer may include a printed trace on at least one surface of the membrane layer. The assemblies may include a ground plane positioned on an opposite side of the membrane layer as the outer top case such that the mechanical support layer and the membrane layer are disposed between the outer top case and the ground plane.

### BACKGROUND OF THE INVENTION

Printed circuit boards (PCBs) are often utilized in computer peripheral devices to carry circuits and for mounting various electrical components. However, the use of PCBs presents sustainability issues that are primarily attributed to the manufacturing techniques required to fabricate the PCB. For example, the PCBs are produced using subtractive manufacturing techniques that rely on several energy-intensive processes and result in large material waste. Such manufacturing techniques produce particularly large carbon footprints for larger peripheral devices, such as keyboards, that require circuitry to connect each key to an integrated circuit and/or other processing chip. Therefore, improvements in sustainable computer peripheral device design are desired.

### BRIEF SUMMARY OF THE INVENTION

Embodiments of the present invention may encompass electronics assemblies of computer peripheral devices. The assemblies may include an outer top case. The assemblies may include a mechanical support layer disposed on an inner side of the outer top case. The assemblies may include a membrane layer coupled with the mechanical support layer. The membrane layer may include a printed trace on at least one surface of the membrane layer. The assemblies may include a ground plane positioned on an opposite side of the membrane layer as the outer top case such that the mechanical support layer and the membrane layer are disposed between the outer top case and the ground plane.

In some embodiments, the ground plane comprises a conductive mesh. The conductive mesh may be printed on the membrane layer on an opposite side of the printed trace. The membrane layer may include one or more vias that extend through a thickness of the membrane layer to electrically couple the ground plane and the printed trace. The assemblies may include an additional membrane layer that is coupled with the mechanical support layer. The additional membrane layer may include an additional printed trace on at least one surface of the additional membrane layer. The assemblies may include an ultraviolet ink insulation layer disposed atop the printed trace. The assemblies may include at least one jumper that extends over the ultraviolet ink insulation layer. The assemblies may include a keyboard switch that extends through the membrane layer and the mechanical support layer.

Some embodiments, of the present technology may encompass electronics assemblies of a computer peripheral device that include an outer top case. The assemblies may include a mechanical support layer. The assemblies may include a first membrane layer coupled with the mechanical support layer. The first membrane layer may include a first trace that is printed on at least one surface of the first membrane layer. The assemblies may include a second membrane layer coupled with the mechanical support layer. The second membrane layer may include a second trace that is printed on at least one surface of the second membrane layer. The assemblies may include a ground plane positioned on an opposite side of the first and second membrane layers as the outer top case such that the mechanical support layer, the first membrane layer, and the second membrane layer are disposed between the outer top case and the ground plane.

In some embodiments, the assemblies may include an additional ground plane positioned between the first and second membrane layers and the outer top case. The ground plane may be printed on one of the first and second membrane layers. The ground plane may be printed on a third membrane layer. The first membrane layer may include one or both of polyethylene terephthalate and a polyamide. The first and second traces may be printed using conductive ink that comprises at least one material selected from the group consisting of silver, carbon, and copper.

Some embodiments of the present technology may encompass electronics assemblies of a computer peripheral device that may include an outer top case. The assemblies may include a mechanical support layer. The assemblies may include a membrane layer coupled with the mechanical support layer. The membrane layer may include a printed circuit on at least one surface of the membrane layer. The printed circuit may include a keyboard matrix. The assemblies may include a ground plane positioned on an opposite side of the membrane layer as the outer top case such that the mechanical support layer and the membrane layer are disposed between the outer top case and the ground plane. The assemblies may include a plurality of switches that each extend through the membrane layer and the mechanical support layer.

In some embodiments, each of the plurality of switches may include an optical key switch. The computer peripheral device may include a plurality of optical sensor assemblies, with an optical sensor assembly of the plurality of optical sensor assemblies being disposed on the membrane layer proximate each of the plurality of plurality of switches. Each optical assembly may include an infrared emitter and a phototransistor. The ground plane may include a conductive mesh that is printed on the membrane layer on an opposite side of the printed circuit. The membrane layer may include a plurality of vias that extend through a thickness of the membrane layer to electrically couple the ground plane and the printed circuit. A respective one of the vias may electrically couple each phototransistor with the ground plane. Each optical key switch may be mounted on the outer top case. The assemblies may include a plurality of RGB diodes that are coupled with the membrane layer.

### BRIEF DESCRIPTION OF THE DRAWINGS

A further understanding of the nature and advantages of the disclosed technology may be realized by reference to the remaining portions of the specification and the drawings.

FIG. 1A illustrates an isometric view of a printed membrane stack according to embodiments of the present invention.

FIG. 1B illustrates a side elevation view of the printed membrane stack of FIG. 1A.

FIG. 2A illustrates a side elevation view of a printed membrane according to embodiments of the present invention.

FIG. 2B illustrates a side elevation view of a printed membrane according to embodiments of the present invention.

FIG. 2C illustrates a side elevation view of a printed membrane according to embodiments of the present invention.

FIG. 2D illustrates a side elevation view of a printed membrane according to embodiments of the present invention.

FIG. 2E illustrates a side elevation view of a printed membrane according to embodiments of the present invention.

FIG. 2F illustrates a side elevation view of a printed membrane according to embodiments of the present invention.

FIG. 3A illustrates a side elevation view of a printed membrane stack according to embodiments of the present invention.

FIG. 3B illustrates a side elevation view of a printed membrane stack according to embodiments of the present invention.

FIG. 3C illustrates a side elevation view of a printed membrane stack according to embodiments of the present invention.

FIG. 3D illustrates a side elevation view of a printed membrane stack according to embodiments of the present invention.

FIG. 4 illustrates an exploded view of an electronics assembly of a peripheral device according to embodiments of the present invention.

FIG. 4A illustrates a partial assembled view of the electronics assembly of FIG. 4.

FIG. 5A illustrates a process of coupling a printed membrane with a mechanical support layer according to embodiments of the present invention.

FIG. 5B illustrates a process of coupling a printed membrane and electrical contacts with a mechanical support layer according to embodiments of the present invention.

FIG. 5C illustrates a process of coupling key switches with a mechanical support layer according to embodiments of the present invention.

FIG. 6A illustrates a side elevation view of an electronics assembly of a peripheral device, with an optical key switch in an open position according to embodiments of the present invention.

FIG. 6B illustrates a side elevation view of an electronics assembly of a peripheral device, with an optical key switch in an open position according to embodiments of the present invention.

FIG. 6C illustrates a side elevation view of the electronics assembly of FIG. 6A, with the optical key switch in a closed position according to embodiments of the present invention.

FIG. 6D illustrates a side elevation view of the electronics assembly of FIG. 6B, with the optical key switch in a closed position according to embodiments of the present invention.

FIG. 7A illustrates a top plan view of a bonding pattern for an LED according to embodiments of the present invention.

FIG. 7B illustrates a top plan view of a bonding pattern for an optical assembly according to embodiments of the present invention.

FIG. 8A illustrates an exploded view of a gaming keyboard according to embodiments of the present invention.

FIG. 8B illustrates a top plan view of a portion of the gaming keyboard of FIG. 8A.

FIG. 8C illustrates a top plan view of a printed membrane stack of the gaming keyboard of FIG. 8A.

Several of the figures are included as schematics. It is to be understood that the figures are for illustrative purposes, and are not to be considered of scale unless specifically stated to be of scale. Additionally, as schematics, the figures are provided to aid comprehension and may not include all aspects or information compared to realistic representations, and may include exaggerated material for illustrative purposes.

### DETAILED DESCRIPTION OF THE INVENTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the present invention are directed to computer peripheral devices (such as keyboards and mice) and electronic assemblies of such devices that replace some or all PCBs with one or more printed membranes. The printed membranes may include a thin, flexible membrane layer that serves as a substrate on which one or more traces may be printed using a conductive ink to form all or a portion of one or more circuits, buses, and/or conductive elements. Such printed membranes are manufactured using additive manufacturing techniques which are less energy intensive and less wasteful of materials than the subtractive manufacturing techniques used to fabricate PCBs. In some instances, such printed membranes may be up to 10 times as sustainable than an equivalent PCB.

While the use of printed membranes and/or other printed electronics has been previously used, the use of such printed membranes presents particular challenges when incorporating the printed membranes into certain advanced computer peripheral devices. For example, gaming keyboards and gaming mice may need to be more robust to hold up to the demands of regular use. However, mechanical and electrical connections between the key switches (and/or other pass-through-hole components) and a printed membrane may be difficult to maintain over time due to the large forces exerted on the keys, as the membrane may shift and/or decouple from the key switches due to relative movement and/or forces between the components. Additionally, due to the large number of keys, lighting elements, dials, and/or other input devices on an advanced computer peripheral (that all need a separate trace to a processing unit of the keyboard) the trace density may be particularly high and difficult to design and fabricate due to limitations of the circuit printing process. Additionally, there may be difficulty in coupling electrical components (such as the switches, diodes, sensors, and the like) to the membrane due to a lower melting point of the membrane itself.

Embodiments of the present invention address these issues by coupling the printed membrane on a rigid mechanical support layer to provide a solid support for any switches, and/or other mounted electronic components to facilitate a more robust electrically connection between the printed membrane and any attached electrical components. Embodiments may also implement customized tracing designs that route higher current traces at areas of the printed membrane that have more free space (e.g., areas near edges of the printed membrane), which may allow such high current traces to be enlarged to prevent voltage drops that may result from the resistance of the conductive ink. Embodiments may utilize low temperature techniques, such as low temperature soldering and/or use of conductive glues, to electrically couple various electrical components to the printed membrane to avoid damaging the membrane through use of conventional high temperature joining techniques.

Through the incorporation of the printed membranes, the use of PCBs may be significantly reduced and/or eliminated in various peripheral devices. Embodiments may therefore provide sustainable peripheral devices and components thereof that are sufficiently robust to be used in demanding applications.

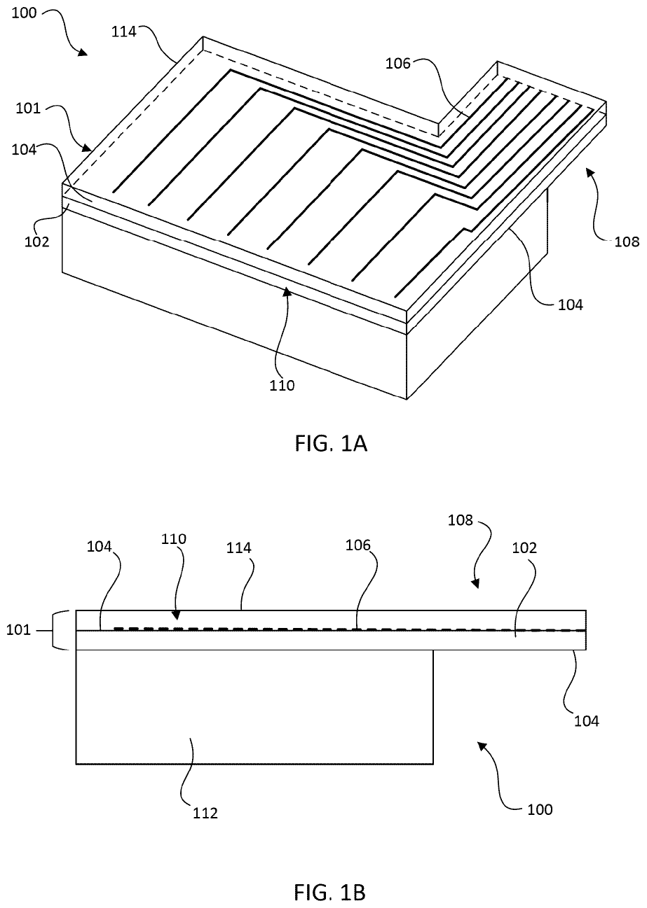

Turning now to FIGS. 1A and 1B, an embodiment of a printed membrane stack 100 is illustrated. Printed membrane stack 100 may form and/or include all or a part of the electronic circuitry of a computer peripheral device, such as a keyboard, mouse, and/or other device that may interface with a computing device. Computing devices may include, for example, personal computers, mobile phones, tablet computers, e-readers, and/or other computing devices. The printed membrane stack 100 may enable the circuitry to be robustly mounted in the peripheral device, while also providing a rigid substrate that provides structural support to facilitate coupling the circuitry with other electrical components of the peripheral device. The printed membrane stack 100 may include one or more printed membranes 101, with each printed membrane 101 includes one or more membrane layers 102. Each membrane layer 102 may be formed of a thin material, oftentimes having a thickness of between about 0.001 inches and 0.1 inches, between about 0.005 inches and 0.05 inches, or between about 0.01 inches and 0.025 inches, although thicker or thinner membrane layers 102 may be utilized in some embodiments. The membrane layer 102 may be formed from various non-electrically conductive materials, such as polymers, glass, ceramic materials, paper, and the like. In a particular embodiment, the membrane layer 102 may be formed from and/or otherwise include a polyester, polyethylene terephthalate, and/or a polyamide. In some embodiments, the membrane layer 102 may be flexible, which may facilitate coupling a portion of the membrane with a connector of a PCB or other structural component as will be described in greater detail below.

Each membrane layer 102 may be formed to have any shape, and may often be formed to conform to the dimensions of a peripheral device housing or portion thereof. As best seen in FIG. 1B, each membrane layer 102 may include two faces 104 that may be substantially planar to provide a suitable surface on which one or more traces 106 may be printed. Each trace 106 may be printed atop a face 104 of the membrane layer 102 using a conductive ink. The conductive ink may include one or more conductive materials such as, but not limited to, silver, carbon, and/or copper. A particular conductive material within the ink, as well as a quantity of the conductive material within the ink (e.g., relative to other components of the ink) may be selected based on various factors such as cost, temperature for curing, duration of curing, performance, resistance, sustainability, and/or other factors. Additionally, the traces 106 may be printed in a single pass or in multiple passes. Each trace 106 may form a portion of one or more circuits. In some embodiments, only a single face 104 of the membrane layer 102 may include traces 106, while in other embodiments both faces 104 of the membrane layer 102 may include traces 106. Some or all of the traces 106 may include solder terminals and/or other contact regions that facilitate electrical coupling of the trace 106 with an electrical component coupled with the membrane layer 102.

In some embodiments, one or more insulator layers 114 may be disposed over all or a portion of one or more of the traces 106. The insulator layer 114 may be formed from a non-electrically conductive material and may help protect the traces 106 from environmental exposure and/or damage, while also helping to prevent the conductive ink from migrating and potentially shorting with another trace 106 over time. In some embodiments, the insulator layer 114 may be formed from a non-electrically conductive ink and/or glue that may be printed atop the traces 106. The insulator layer 114 may be colored to perform specific functions in some embodiments. For example, the insulator layer 114 may be black or another dark color to prevent light leakage when used to insulate traces 106 used with light-emitting diodes (LEDs) and/or light sensors (such as phototransistors). Similarly, the insulator layer 114 may be white or other light color to boost the efficiency of light emitted by LEDs affixed to the membrane layer 102.

Traces 106 with different functions may be printed on the same or different faces 104 of a single membrane layer 102 and/or may be printed on different membrane layers 102. Separating traces 106 onto different membrane layers 102 may reduce the trace density on a given membrane layer 102 and/or face 104 and may enable a greater number of traces 106 with a greater number of functions to be included in the printed membrane stack 100. In a particular example, for a gaming keyboard, traces 106 for each key switch may be printed on a different face 104 and/or membrane layer 102 than traces 106 for LEDs (such as red-green-blue (RGB) LEDs). Additionally, some embodiments of printed membrane stack 100 may include a ground plane, which may be implemented as a printed mesh of traces 206 in some instances. The ground plane may be printed on a different face 104 and/or membrane layer 102 than traces 106 that provide circuitry for various electrical components of a peripheral device. In some embodiments, the printed membrane stack 100 may include one or more jumper layers that extend over one or more of the traces 106. For example, the insulator layer 114 may be disposed atop all or a portion of one or more of the traces 106 to enable traces 106 to cross or jump over one another without being electrically coupled.

The membrane layer 102 may include one or more fingers 108 that may extend laterally outward from a main body 110 of the membrane layer 102. The fingers 108 may provide an interconnection region to connect the traces 106 to one or more PCBs, processors, and/or other electrical components. For example, in some embodiments some or all of the traces 106 may extend from the main body 110 of the membrane layer 102 to one or more of the fingers 108. This may enable signals from electrical components, such as switches, diodes, sensors, etc. that are electrically coupled with the traces 106 to be connected to one or more processing units that may control operation of the various components. For example, some or all of the traces 106 may extend between at least one of the fingers 108 and a connection point on the membrane layer 102 for one or more electrical components (e.g., switches, diodes, sensors, etc.). Once the fingers 108 are coupled with a processing unit, each trace 106 may form at least a portion of a circuit path between a given electrical component and a processing unit.

The printed membrane stack 100 may include a mechanical support layer 112 that may provide a substantially rigid substrate on which the membrane layer 102 may be mounted. For example, a face 104 of the membrane layer 102 may be coupled with a surface of the mechanical support layer 112. The coupling between the two surfaces may be done using various techniques such as, but not limited to, use of one or more adhesives, ultrasonic welding, hot stacking, one or more fasteners, a snap-fit coupling, being pressed into/onto one another, and/or other techniques. In embodiments where the membrane layer 102 is a polymeric material, lower temperature joining techniques (such as use of adhesives, ultrasonic welding, fasteners, etc.) may be preferred to avoid the joining technique using temperatures that may affect the integrity of the polymeric membrane layer 102. The mechanical support layer 112 may be formed from and/or otherwise include a rigid material, such as plastic, polymers, metals, wood, ceramic, and the like. In embodiments in which a face 104 of the membrane layer 102 that includes one or more traces 106 is positioned directly against the mechanical support layer 112, at least an outer surface of the mechanical support layer 112 may be formed from a non-electrically conductive material to prevent shorting of the traces 106.

The mechanical support layer 112 may be substantially planar as illustrated. However, in other embodiments, the mechanical support layer 112 may define one or more three dimensional features that protrude from or are recess relative to a primary surface of the mechanical support layer 112. For example, the mechanical support layer 112 may define one or more sockets for receiving switches and/or other electrical components. The sockets may include one or more protruding regions and/or recessed regions that facilitate mechanical and/or electrical coupling of switches or other components with the mechanical support layer 112 and/or membrane layer 102.

The mechanical support layer 112 may have any shape and/or dimensions. In some embodiments, a general shape of the mechanical support layer 112 may generally match the shape of the membrane layer 102 or the main body 110 of the membrane layer 102. For example, the mechanical support layer 112 may be shaped to generally match the main body 110 of the membrane layer 102 while all or a portion of each finger 108 extends laterally outward beyond a peripheral of the mechanical support layer 112. In some embodiments, the mechanical support layer 112 may be substantially (e.g., within 20%, within 10%, within 5%, within 3%, within 1%, or less) the same size as the membrane layer 102, while in other embodiments, the mechanical support layer 112 may be smaller or larger than the membrane layer 102. As just one example, the mechanical support layer 112 may be slightly larger than the membrane layer 102 to enable a full coupling surface (e.g., face 104 that is adjacent the mechanical support layer 112, with or without the fingers 108) of the membrane layer 102 to be disposed against a corresponding surface of the mechanical support layer 112 such that the mechanical support layer 112 may provide a rigid substrate for at least the main body 110 of the membrane layer 102. Additionally, by making the mechanical support layer 112 larger than the membrane layer 102 space may be available on the mechanical support layer 112 to receive fasteners and/or other coupling members without needing to penetrate the membrane layer 102. The mechanical support layer 112 may often have a thickness of between about 0.1 inch and 1 inch and more commonly between about 0.25 inch and 0.5 inch, although the dimensions may be larger or smaller depending on the material of the mechanical support layer 112 and the needs of a particular application.

While shown as solid, continuous structures, the membrane layer 102 and/or mechanical support layer 112 may define one or more apertures therethrough that may facilitate mechanical and/or electrical coupling of one or more components to the mechanical support layer 112 and/or membrane layer 102. For example, the apertures may be sized and positioned to receive one or more mechanical coupling features of electrical components (such as switches, sensors, diodes, etc.) to enable the mechanical support layer 112 to provide structural support for the electrical component. The apertures may enable an electrical contact of a given electrical component to be inserted through the mechanical support layer 112 and/or membrane layer 102 and contact one of the traces 106 to enable the electrical component to be electrically coupled with the trace 106.

It will be appreciated that multiple membrane layers 102 may be included in a single printed membrane stack 100. For example, the printed membrane stack 100 may include one or more membrane layers 102 on a single side of the mechanical support layer 112 (e.g., with a number of membrane layers 102 stacked atop one another) and/or the printed membrane stack 100 may include one or more membrane layers 112 on each side of the mechanical support layer 112. Additionally, while shown with a single mechanical support layer 112, it will be appreciated that multiple mechanical support layers 112 may be utilized in various embodiments. For example, a mechanical support layer 112 may be positioned on either side of each membrane layer 112 and/or each group of membrane layers 112.

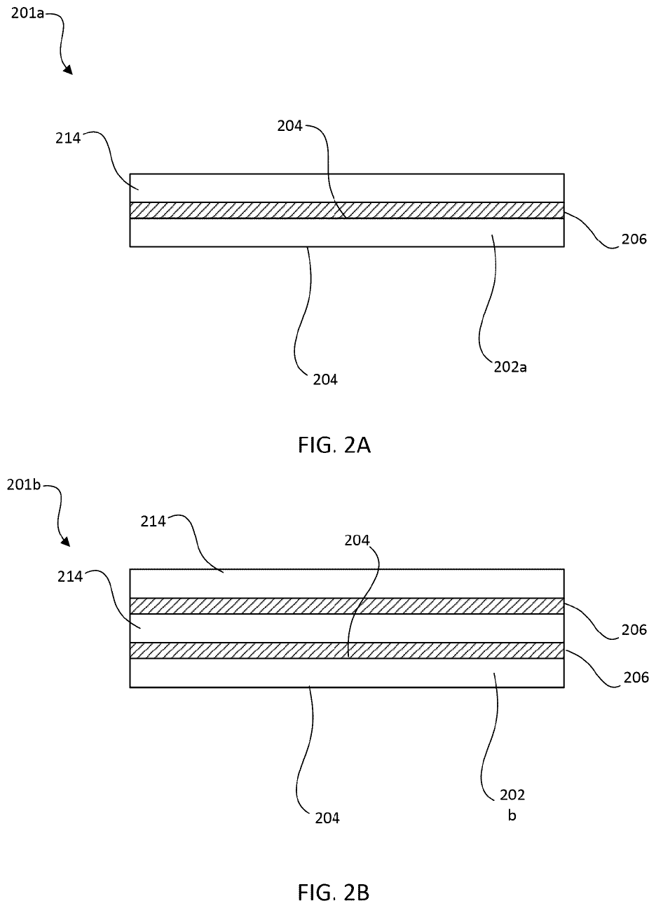

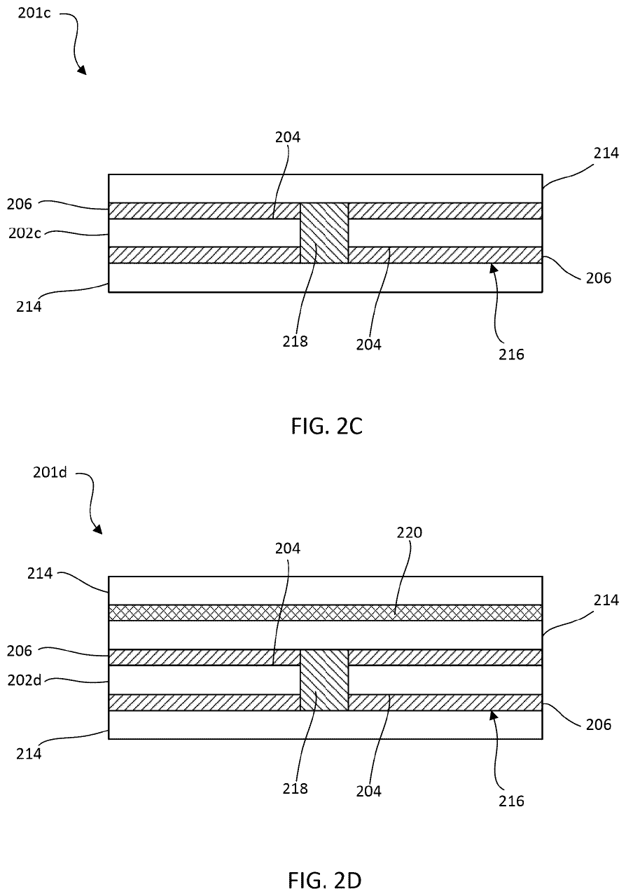

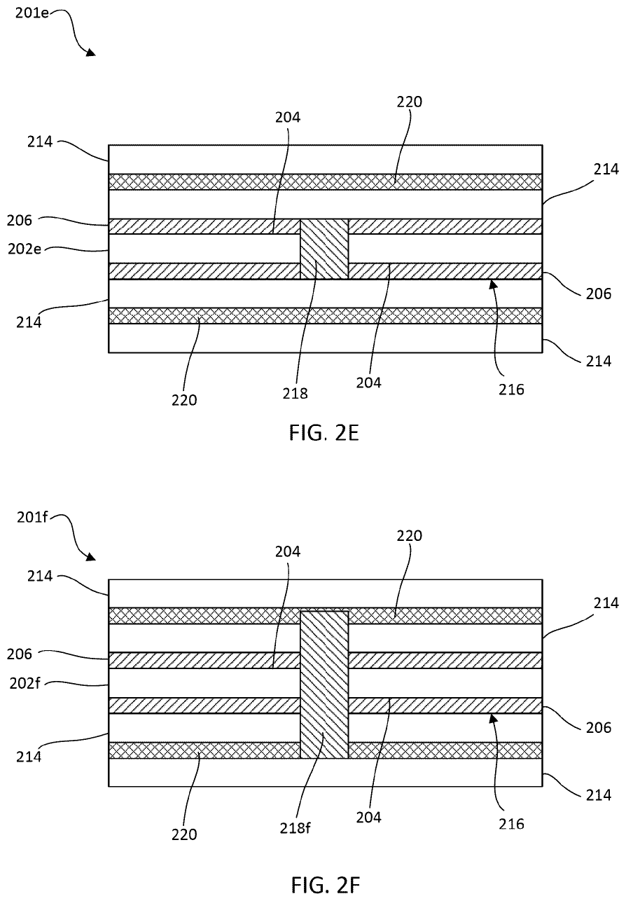

FIGS. 2A-2F illustrate various embodiments of printed membranes 201. Each printed membrane 201 may include a membrane layer 202 (which may be similar to membrane layer 102 and may include any of the features described in relation to membrane layer 102) and one or more traces 206. Each membrane layer 202 may include two faces 204. One or both of the faces 204 may include one or more traces 206, jumpers, and/or insulator layers 214. Turning to FIG. 2A, a basic printed membrane 201a is illustrated. Printed membrane 201a includes a membrane layer 202a that includes one or more traces 206 printed on one face 204 of the membrane layer 202a. An insulation layer 214 may be printed, deposited, and/or otherwise formed over all or a portion of the traces 206 such that the traces 206 are sandwiched between the membrane layer 202a and the insulation layer 214. FIG. 2B illustrates a printed membrane 201b that includes a membrane layer 202b that has two layers of traces 206 printed atop a single face 204 of the membrane layer 202b. The two layers of traces 206 are isolated from one another by an insulator layer 214, with a second insulator layer 214 covering the outermost layer of traces 206. It will be appreciated that any number of layers of traces 206 may be printed on a given membrane layer 202 with the layers being separated by an isolator layer 214.

As noted above, in some embodiments a membrane layer 202 may include traces 206 printed on both faces 204 of the membrane layer 202. FIGS. 2C-2F illustrate embodiments of printed membranes 201 that include traces 206 printed on both faces 204 of a membrane layer 202. For example, FIG. 2C illustrates a printed membrane 201c that include a single layer of traces 206 on each face 204 of the membrane layer 202c. Each layer of traces 206 may be covered by an isolator layer 214. In some embodiments, traces 206 from one face 204 may need to be electrically coupled with traces 206 on the other face 206. For example, one of the layers of traces 206 may form a ground plane 216, which may be a conductive mesh formed by printed ink in some embodiments. One or more traces 206 from a circuit layer (such as for circuitry that facilitates operation of key switches, diodes, sensors, etc.) may need to be coupled with the ground plane 216. In such embodiments, one or more vias 218 may be formed through the membrane layer 202c (such as through apertures formed through the membrane layer 202c) that electrically couple the two layers of traces 206 (e.g., the circuitry layer and the ground plane 216) together. For example, vias 218 may be formed by filling up a drilled (or otherwise formed) hole cavity within the membrane layer 202c and/or a mechanical support layer with conductive ink (or other conductive material).

FIG. 2D illustrates a printed membrane 201d that include a single layer of traces 206 on each face 204 of the membrane layer 202d. Each layer of traces 206 may be covered by an isolator layer 214. The isolator layer 214 may include an ultraviolet ink and/or adhesive in various embodiments. On one side of the membrane layer 202d one or more jumper layers 220 may be disposed atop the traces 206. An additional isolator layer 214 may be printed or otherwise formed atop each jumper layer 220 to electrically isolate each jumper layer 220 from other conductive features. In some embodiments, one or more vias 218 may be formed through the membrane layer 202d to electrically couple two layers of traces 206 together. FIG. 2E illustrates a printed membrane 201e that is similar to printed membrane 201d except that each side of the membrane layer 202e includes one or more jumper layers 220 disposed atop the traces 206. An additional isolator layer 214 may be printed or otherwise formed atop each jumper layer 220 to electrically isolate each jumper layer 220 from other conductive features. In some embodiments, one or more vias 218 may be formed through the membrane layer 202d to electrically couple two layers of traces 206 together. In some embodiments, such as illustrated in FIG. 2F, vias 218f may couple different jumper layers 220 together. For example, a jumper layer 220 formed on a first face 204 may be electrically coupled with one or more other jumper layers 220 on the first face and/or one or more jumper layers 220 on a second face 204 of the membrane layer 202e. Such vias 218f may electrically couple only two or more jumper layers 220 together and/or may couple one or more of the jumper layers 220 with one or more of the layers of traces 206.

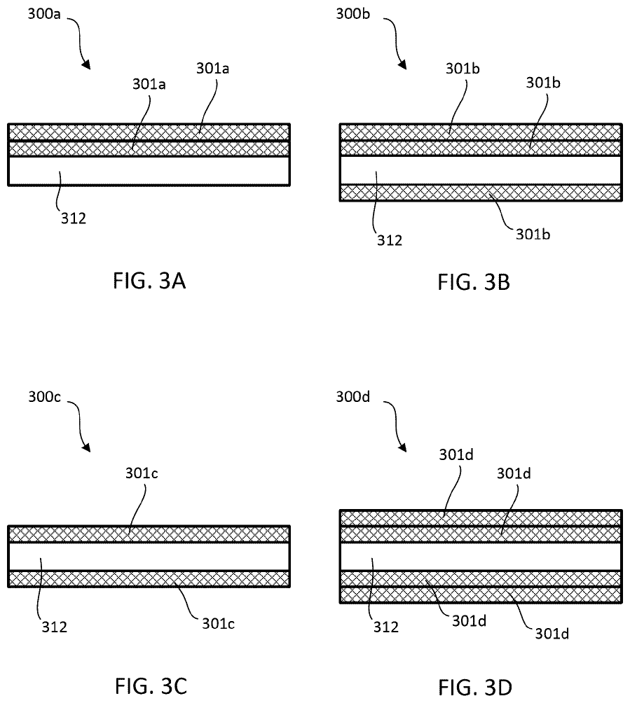

FIGS. 3A-3D illustrate additional printed membrane stacks 300 that may include one or more printed membranes 301 and one or more mechanical support layers 312. The printed membranes 301 may be similar to and include any feature described in relation to printed membranes 101 and 201 and the mechanical support layers 312 may be similar to and include any feature described in relation to mechanical support layer 112. FIG. 3A illustrates a printed membrane stack 300a that includes two printed membranes 301a positioned on a single side of a mechanical support layer 312. The printed membranes 301a may be coupled with one another using various techniques, such as using one or more adhesives, ultrasonic welding, hot stacking, one or more fasteners, a snap-fit coupling, being pressed into/onto one another, and/or other techniques. FIG. 3B illustrates a printed membrane stack 300b that includes a single printed membrane 301b positioned on one side of a mechanical support layer 312 and two printed membranes 301b positioned on an opposite side of the mechanical support layer 312. FIG. 3C illustrates a printed membrane stack 300c that includes a single printed membrane 301c positioned on each side of a mechanical support layer 312. FIG. 3D illustrates a printed membrane stack 300d that includes two printed membranes 301d positioned on each side of a mechanical support layer 312. It will be appreciated that numerous variations exist, and that the printed membrane stacks 300 may be symmetrical or asymmetrical about the mechanical support layer 312.

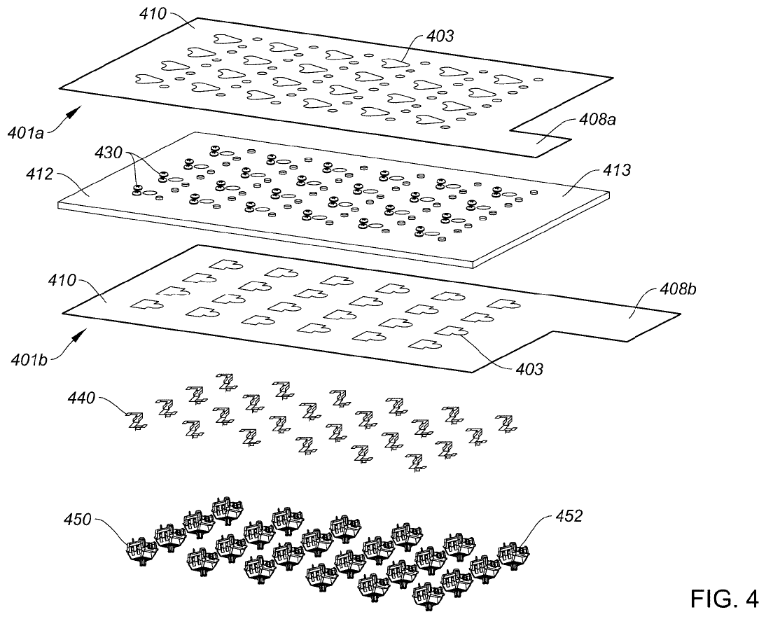

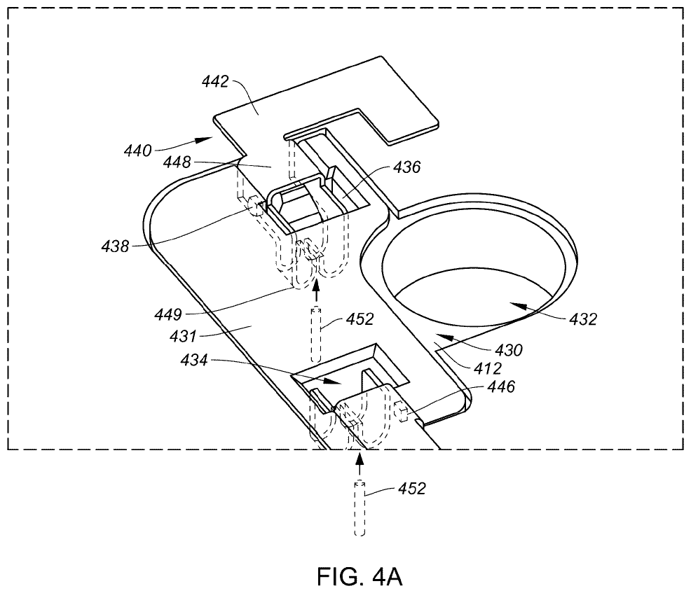

As noted above, the printed membrane stacks described herein may be used to form all or part of one or more circuits that are used to couple various electrical components to one or more processing units of a peripheral device. FIGS. 4 and 4A illustrate an electronics assembly that enables one or more printed membrane stacks to couple various electrical components to a processing unit of a peripheral device. As illustrated, the peripheral device is a keyboard, such as a mechanical gaming keyboard, however it will be appreciated that a similar electronics assembly may be utilized in numerous other peripheral devices, such as other keyboards, mice, touch terminals, and the like. The assembly may include one or more printed membrane stacks 400, which may be similar to the other printed membrane stacks described herein (e.g., printed membrane stack 100 and printed membrane stack 300) and may include any of the features described in relation to those printed membrane stacks. For example, each printed membrane stack 400 may include one or more printed membranes 401, which may be similar to and include any of the features described in relation to printed membranes 101, 201, and/or 301. As illustrated, the assembly includes a single printed membrane stack 400 that includes a mechanical support layer 412 and one printed membrane 401 affixed to each of a top and bottom surface of the mechanical support layer 412. In the illustrated embodiment, each printed membrane 401 includes a membrane layer (such as membrane layer 102, 202, 302) that includes one or more traces printed on a face of the membrane layer. For example, a top printed membrane 401a includes traces that form at least a portion of an LED circuit. Each trace on the top printed membrane 401a may be coupled with an LED, such as an RGB LED, which may be affixed to the membrane layer in some embodiments. A bottom printed membrane 401b may include traces that form at least a portion of a key matrix for the keyboard. Each trace of the bottom printed membrane 401b may be coupled with a key switch 450, such as a mechanical key switch, of the keyboard. The LED circuitry may be positioned closer to the top of the electronics assembly to provide greater efficiency, as putting the LEDs and LED circuitry closer to the top of the keyboard may increase the light efficiency of the light projection of each LED. However, in some embodiments, the positions of the LED circuitry and the key matrix may be switched.

A number of sockets 430 may be formed within and/or coupled with the mechanical support layer 412. As illustrated, the sockets 430 are formed integrally with the mechanical support layer 412, although in other embodiments the sockets 430 may be separately formed and later coupled to the mechanical support layer 412, such as via adhesive bonding, ultrasonic welding, snap fit connections, fasteners, and/or other joining techniques. As best illustrated in FIG. 4A, each socket 430 may define one or more receptacles and/or other engagement features that may be used to couple a key switch 450 and/or electrical contact 440 to the mechanical support layer 412 and one or more traces of at least one of the printed membranes 401. When the sockets 430 form part of a keyboard, the sockets 430 may be arranged to match a layout of the keys of the keyboard to enable a key switch 450 for each key of the keyboard to be mechanically and/or electrically coupled with the mechanical support layer 416 and/or one or both printed membranes 401. Each printed membrane 401 may include one or more apertures 403 and/or other features to accommodate the sockets 430, any/or other mounting features of the mechanical support layer 412 and to help properly align the printed membrane 401 with the mechanical support layer 412. The apertures 403 may also enable a portion of key switches 450, electrical contacts 440, and/or other electrical components to be passed through the printed membrane 401.

Sockets 430 may take various forms depending on the geometry of the electrical contacts 440, key switches 450, and/or other electrical components that are being coupled with the sockets 430. As best illustrated in FIG. 4A, each socket 430 may define or otherwise include at least one recess or aperture 432 which may extend through all or a part of a thickness of the mechanical support layer 416. The apertures 432 may be sized to receive a post and/or other mounting feature of a given key switch 450 to enable the key switch 450 to be rigidly coupled with the mechanical support layer 416. Each socket 430 may define one or more additional apertures 434 that are sized and shaped to receive and secure an electrical contact 440 therein. For example, sidewalls 436 defining lateral boundaries of each aperture 434 may include at least one recess or ledge 438 that has a greater diameter (or other lateral dimension) than a surrounding portion of the aperture 434. The ledge 438 may be engaged with a hook or other snap-fit feature 446 of an electrical contact 440 inserted within the aperture 434 to secure the electrical contact 440 within the aperture 434. For example, as the electrical contact 440 is inserted within the aperture 434, an outer wall of the electrical contact 440 containing the snap-fit feature 446 may be deflected inward until reaching the ledge 438, at which point the snap-fit feature 446 may rebound laterally outward and engage with the surface of the ledge 438 to create an interference fit that prevents the electrical contact 440 from disengaging from the socket 430.

In some embodiments, a portion 431 of each socket 430 that defines the apertures 434 may be elevated relative to a main surface 413 of the mechanical support layer 412. In a particular embodiment, the raised portion 431 of each socket 430 may protrude above the main surface 413 of the mechanical support layer 416 by approximately a distance that is equivalent to a thickness of the printed membrane 401, which may enable outer-facing surface of the printed membrane 401 to be substantially coplanar with the outer-facing surface of the portion 431 of each socket 430. For example, the raised portion 431 of each socket 430 may protrude above the main surface 413 of the mechanical support layer 416 by between about 0.001 inches and 0.1 inches, between about 0.005 inches and 0.05 inches, or between about 0.01 inches and 0.025 inches, although the portion 431 of each socket 430, although other distances are possible in various embodiments.

In some embodiments, each electrical contact 440 may be in the form of a contact pin that is inserted within a respective socket 430 to provide an interconnect point between a particular key switch 450 and a trace printed on at least one of the printed membranes 401. For example, as illustrated, each electrical contact 440 may be inserted into a socket 430 from a bottom side of the mechanical support layer 416 and bottom printed membrane 401b to sandwich the printed membrane 401b between the mechanical support layer 412 and the electrical contact 440. As best shown in FIG. 4A, contact terminal 442 of the electrical contact 440 may extend laterally outward from a main body 448 of the electrical contract 440 and extend over a portion of the printed membrane 401b. At least a portion of the contact terminal 442 may contact and/or otherwise be proximate an exposed portion of one of the traces (e.g., a soldering pad) of the printed membrane 401b. Such positioning of the contact terminal 442 may facilitate soldering and/or otherwise electrically coupling the contact terminal 442 with the exposed portion of the trace.

In some embodiments, the contact terminal 442 may include a substantially planar member that extends over at least one printed membrane 401 (e.g., printed membrane 401b) that sandwiches the printed membrane 401 between the mechanical support layer 412 and the electrical contact 440. For example, a width of the contact terminal 442 may be greater than a thickness of the contact terminal 442 to provide a large surface area to provide a better surface to facilitate soldering and/or other electrical coupling between the contact terminal 442 and a trace of the printed membrane 401. For example, the width of the contact terminal 442 may be between about 2 to 30 times larger than a thickness of the contact terminal 442, between 5 and 25 times larger, or between 10 and 20 times larger in various embodiments. The contact terminal 442 may have any shape. In some embodiments, the contact terminal 442 may be L-shaped, U-shaped, and/or other nonlinear shape, and in particular a shape that bends about an axis extending through the thickness of the contact terminal 442. Such shapes may provide a large surface area for receiving solder and/or other electrical joining material (such as conductive adhesive) while also providing a longer border about the length of the contact terminal 442. This increased length may create a larger surface area for solder and/or other electrical joining material to flow between edges of the contact terminal 442 and a surface of the printed membrane 401. The electrical contacts 440 may be formed from a conductive material and/or coated conductive material, and oftentimes with a solder-compatible material. For example, in a particular embodiment the electrical contacts 440 may be formed from copper (or other metal) that is coated with tin to facilitate soldering of the electrical contact 440 to a solder terminal of a given trace.

As noted above, certain materials that may be used for the membrane layer of the printed membrane 401 may have low melting points that may make it difficult to utilize conventional soldering techniques to electrically couple the electrical contacts 440 with traces on the printed membrane 401 without risking damage to the membrane layer. Therefore, some embodiments may use low temperature joining techniques, such as low-melt solder (e.g., solder compositions having melting points lower than a melting point of the membrane layer), conductive adhesives, and/or other electrical joining techniques.

As noted above, a body 448 of the electrical contact 440 positioned within the aperture 434 may include one or more snap-fit features 446 that may be used to secure the electrical contact 440 within a given aperture 434. The body 448 may also include one or more electronic pins or contacts 449 that may be oriented in a direction opposite the contact terminal 442. For example, as illustrated each lateral side of the body 448 may include a contact 449 in the form of a hooked pin, with the distal end of each hooked pin facing a central axis of the body 448. This configuration enables a contact pin 452 of a key switch 450 to be interfaced with the hooked pins to electrically couple the key switch 450 with the electrical contact 440 and printed membrane 401. For example, the contact pin 452 may be inserted between the two hooked pins, with the two hooked pins pinching against the contact pin 452 to establish an electrical connection with the electrical contact 440.

While discussed with the bottom printed membrane 401b (with the keyboard matrix traces) and electrical contacts 440 being positioned on a bottom surface of the mechanical support layer 412 (with the LED circuit on a top surface of the mechanical support layer 412), it will be appreciated that the orientation may be reversed or otherwise altered in various embodiments. For example, the printed membrane 401 with the keyboard matrix traces and electrical contacts 440 may be provided on an upper surface of the mechanical support layer 412, with the electrical contacts 440 being designed to insert from the upper direction with the contacts 449 still facing the upward direction to receive a contact pin 452 from a key switch 450 positioned on the upper side of the mechanical support layer 412. When electrically coupled with the traces forming the key matrix, each mechanical key switch 450 may transmit a switch-closed signal to a processing unit of the keyboard using at least one of the traces. For example, when the mechanical key switch 450 is depressed, a portion of the mechanical key switch 450 may close a circuit that enables a signal to be sent to the processing unit that the switch/circuit was closed, which may result in the keyboard sending a signal to an attached computing device that an input associated with the key switch has been made.

Each printed membrane 401 may include one or more fingers 408 that may extend laterally outward from a main body 410 of the membrane layer 402 to provide an interconnection region to connect traces to one or more PCBs, processors, and/or other electrical components of a peripheral device. As illustrated, each finger 408 extends from a side surface of a respective membrane layer 402, however in other embodiments one or more fingers 408 may extend from a front or rear surface of the membrane layer 402. The fingers 408 for each printed membrane 401 may extend from a same or different side and may be aligned with one another in some embodiments. As illustrated, the fingers 408 are laterally offset from one another, with a top finger 408a being positioned further rearward than a lower finger 408b, although other configurations are possible in various embodiments.

Although not shown here, the electronics assembly may include a ground plane that may encapsulate one or more of the printed membranes 401 between the ground plane and a top outer case or housing of the keyboard or other peripheral device. For example, the ground plane may be positioned on an opposite side of one or more of the printed membranes 401 and the top outer case. In some embodiments, the ground plane may be formed as a conductive mesh circuit. The ground plane may be fabricated using additive manufacturing techniques in some embodiments to further improve the sustainability of the peripheral device. In some embodiments, the ground plane may be formed by printing a conductive mesh pattern on a membrane layer of a printed membrane 401 using a conductive ink (similar to the traces). In such embodiments, the ground plane may be included on printed membrane 401a, 401b, and/or on another printed membrane, such as a printed membrane that is dedicated to the ground plane. In some embodiments, the ground plane may be printed on a case of a peripheral case such as, but not limited to, an outer bottom case of a keyboard.

It will be appreciated that the assembly configuration described above is merely provided as one example of an assembly for coupling one or more electrical components to one or more processing units of a peripheral device and that numerous variations may exist. For example, the LED circuitry printed membrane may be omitted and/or additional layers with various functionality may be included. For example, one or more printed membranes with traces for dials, speakers, microphones, biometric readers, and/or other features of the keyboard or other peripheral device may be included. Such traces may be provided on a same or different face of an existing printed membrane 401 and/or one or more sets of traces may be provided on a separate printed membrane.

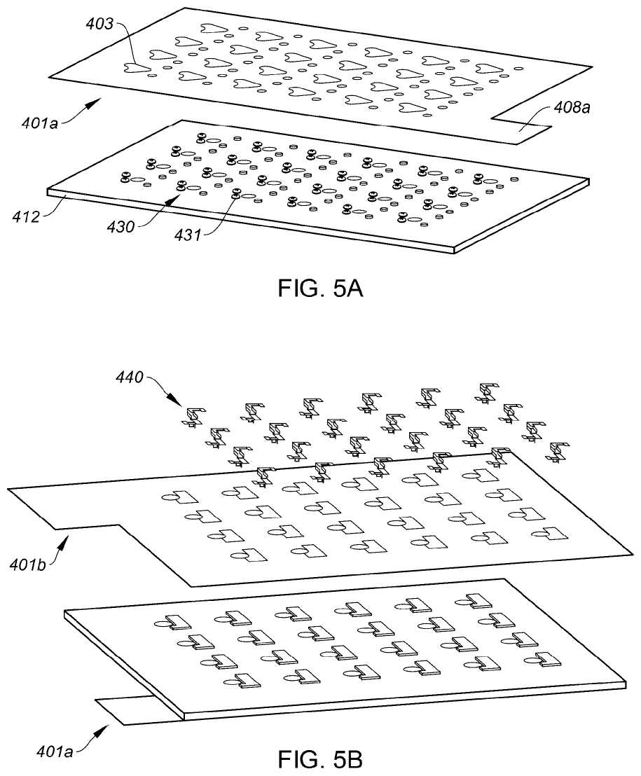

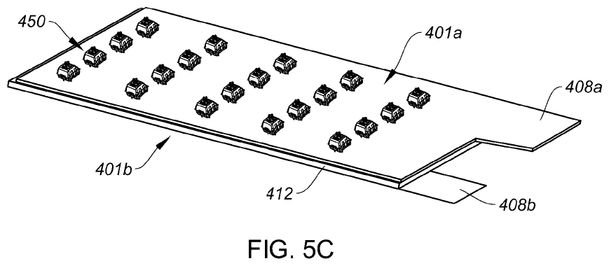

FIGS. 5A-5C illustrate one embodiment of a process for assembling the assembly illustrated in FIGS. 4 and 4A. An initial step may include printing one or more traces on a membrane layer of each printed membrane 401 used in the assembly. As described above, each trace may be covered with at least one insulator layer, which may protect the traces from environmental exposure and may prevent the conductive material within each trace from migrating and potentially shorting with another trace. Once printed membrane 401a is fabricated, the printed membrane 401a may be aligned and joined to the mechanical support layer 412 as shown in FIG. 5A. In embodiments in which sockets 430 are provided on the mechanical support layer 412, apertures 403 formed through the printed membrane 401 may be aligned with the sockets 430 to properly align the printed membrane 401 and mechanical support layer 412. In some embodiments, protruding portions 431 of each socket 430 may help self-align the printed membrane 401a when the protruding portions 431 are inserted within the apertures 403. The coupling between the printed membrane 401 and mechanical support layer 412 may be performed using one or more adhesives, ultrasonic welding, hot stacking, one or more fasteners, a snap-fit coupling, being pressed into/onto one another, and/or other techniques. In the illustrated embodiment, when the printed membrane 401a and mechanical support layer 412 are joined, the finger 408a of the membrane layer of the printed membrane 401a may extend laterally outward beyond a peripheral edge of the mechanical support layer 412, which may facilitate coupling of ends of the traces present on the finger 408a with one or more processing units and/or other components of the peripheral device.

As shown in FIG. 5B, once the printed membrane 401a is joined with mechanical support layer 412, the printed membrane 401b may be secured to an opposite face of the mechanical support 412. Coupling the printed membrane 401b to the mechanical support 412 layer done in a similar manner as with the printed membrane 401a. The finger 408b may extend laterally outward from the mechanical support layer 412. In some embodiments, the fingers 408 of different printed membranes 401 may be aligned with one another, while in other embodiments the fingers 408 from different printed membranes 401 may be laterally offset from one another, which may facilitate easier coupling of the fingers 408 with connectors that electrically couple the fingers 408 (and traces printed thereon) to one or more processing units of a peripheral device. Upon affixing the printed membrane 401b to the mechanical support layer 412, a number of electrical contacts 440 may be coupled with the mechanical support layer 412. For example, the body 448 of each electrical contact 440 may be inserted through an aperture 434 formed in a given socket 430 until the snap-fit feature 446 engages the ledge 438 or other coupling feature of the sidewall defining the lateral boundary of the aperture 434. Once the snap-fit feature 446 is engaged with the ledge 438 the contact terminal 442 of the electrical contact 440 may sandwich the printed membrane 401b between the electrical contact 440 and the mechanical support layer 412 (as shown in FIG. 4A). The contact terminals 442 may each be electrically coupled with one or more traces of the printed membrane 401b, such as by soldering, low melt soldering, conductive adhesive, and/or other electrical joining technique. Once the electrical contacts 440 have been electrically coupled with the printed membrane 401b, a number of key switches 450 may be mechanically and electrically coupled with the printed membrane 401b and mechanical support 412 as shown in FIG. 5C. For example, one or more posts or other engaging features of each key switch 450 may be inserted into one or more apertures 432 of the mechanical support layer 412 to mechanically couple the key switch 450 to the mechanical support layer 412, while each contact pin 452 of the key switch 450 is inserted into a receptacle and/or other contact 449 (such as hooked pins) of the electrical contact 440 to electrically couple the key switch 450 to the electrical contact 440 and trace of the printed membrane 401b.

It will be appreciated that the process for assembling the assembly of FIGS. 4 and 4A is merely one example of such a process and that numerous variations exist. For example, the coupling of the printed membranes 401 with the mechanical support layer 412 may be reversed in some embodiments, while the coupling of the electrical contacts 440 may be performed after a single printed membrane 401b has been coupled with the mechanical support layer 412 or after both printed membranes 401 have been coupled with the mechanical support layer 412. Additionally, while described as coupling the printed membranes 401 to the mechanical support layer 412 after the traces have been printed on the membrane layer, in some embodiments the traces may be printed after the printed membranes 401 have been coupled to the mechanical support layer 412. Embodiments including multiple printed membranes 401 on a given side of the mechanical support layer 412 may include additional steps to secure multiple printed membranes 401 together before and/or after attaching the printed membranes 401 to the mechanical support layer 412. The joining of multiple printed membranes 401 may involve the use of similar techniques as used to join the printed membranes 401 to the mechanical support layer 412, such as by using one or more adhesives, ultrasonic welding, hot stacking, one or more fasteners, a snap-fit coupling, being pressed into/onto one another, and/or other techniques.

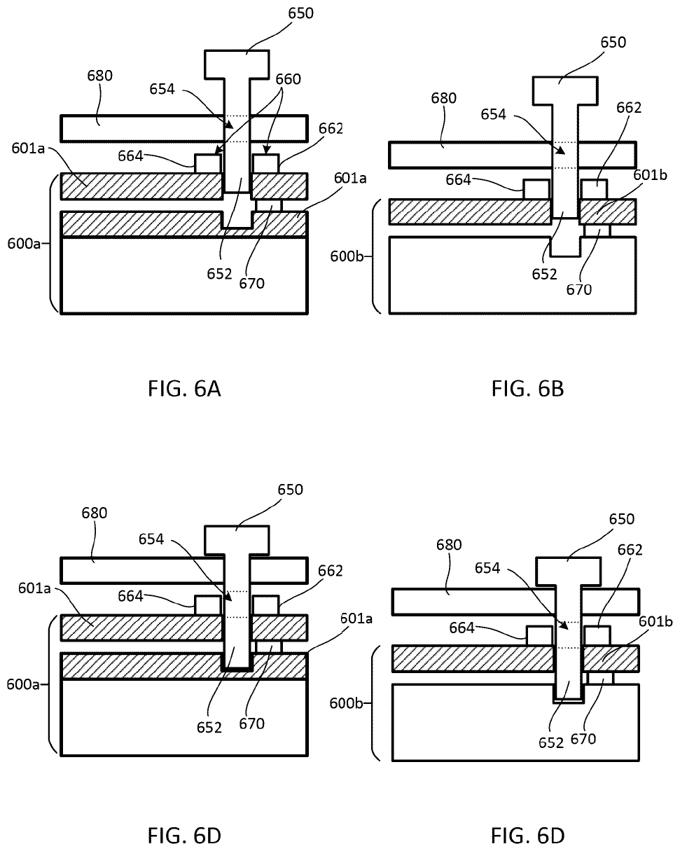

FIGS. 6A-6D illustrate an electronics assembly that enables one or more printed membrane stacks to couple various electrical components to a processing unit of a peripheral device. As illustrated, the peripheral device is a keyboard, such as a mechanical gaming keyboard that uses optical key switches, however it will be appreciated that a similar assembly may be utilized in numerous other peripheral devices, such as other keyboards, mice, touch terminals, and the like. The use of optical key switches, rather than mechanical, may prevent the need for the key switches to be mechanically coupled to the printed membranes (e.g., there will be no need for connections with contact terminals that are soldered and/or otherwise conductively adhered to a printed membrane), which may improve the robustness of the keyboard or other peripheral device. The assembly may include one or more printed membrane stacks 600, which may be similar to the other printed membrane stacks described herein (e.g., printed membrane stack 100, printed membrane stack 300, and printed membrane stack 400) and may include any of the features described in relation to those printed membrane stacks. For example, each printed membrane stack 600 may include one or more printed membranes 601, which may be similar to and include any of the features described in relation to printed membranes 101, 201, 301, and/or 401. In the embodiment of FIGS. 6A and 6C, the electronics assembly includes a single printed membrane stack 600a that includes a mechanical support layer 612 and two printed membranes 601a affixed to a top surface of the mechanical support layer 612. For example, one of the printed membranes 601a may include one or more traces that form at least a portion of LED circuitry (such as an LED for each key of the keyboard and/or other LED positions), while the other printed membrane 601a includes traces that form a key matrix for the keyboard. In the embodiment of FIGS. 6B and 6D the electronics assembly includes a single printed membrane stack 600b that includes a mechanical support layer 612 and a single printed membrane 601b affixed to a top surface of the mechanical support layer 612. The printed membrane 601b may include one or more traces that form at least a portion of LED circuitry (such as an LED for each key of the keyboard and/or other LED positions) and one or more traces that form a key matrix for the keyboard. In some embodiments, the traces for the LED circuitry and the key matrix may be printed on a same face of the membrane layer of the printed membrane 601b, while in other embodiments the traces for the LED circuitry may be printed on one face while the key matrix is printed on the opposite face. It will be appreciated that other traces may be included on one or more printed membranes 601 in various embodiments. The relative positions of the LED circuitry and keyboard matrix may be varied. For example, as illustrated the keyboard matrix may be positioned closer to the top of the assembly, however in other embodiments the LED circuitry may be closer to the top of the keyboard.

The electronics assembly may include a number of additional components, such as electrical components. For example, the electronics assembly may include a number of optical key switches 650, an optical assembly 660 for each of the optical key switches 650, and/or a number of LEDs 670 (such as an LED for each optical key switch 650 and/or other component). Components of the optical assembly 660 may be electrically and mechanically coupled with the printed membrane 601 and traces forming the key matrix. For example the key matrix may include one or more traces for each optical key switch 650 to electrically couple the optical assembly 660 of each optical key switch 650 with a processing unit of the keyboard. Each optical assembly 660 may include an optical signal emitter 662 (such as, but not limited to, an infrared diode) and an optical receiver 664 (such as, but not limited to, a phototransistor). The optical signal emitter 662 and the optical receiver 664 may be both mechanically and electrically coupled with one or more traces of a printed membrane 601. For example, the optical signal emitter 662 and the optical receiver 664 may be soldered (e.g., using low-melt soldering techniques), conductively adhered, and/or otherwise physically coupled with the printed membrane 601. When physically coupled using conductive materials, the optical signal emitter 662 and the optical receiver 664 may also be coupled with one or more traces that may supply power and/or communicate other signals between one or more processing units of the peripheral device and the optical signal emitter 662 and/or the optical receiver 664.

Each optical key switch 650 may include an optical barrier 652, such as a post, that may be vertically translated when the optical key switch 650 is actuated. The optical barrier 652 may prevent light emitted from the optical signal emitter 662 from being detected by the optical receiver 664 when the optical key switch 650 is in a neutral position (e.g., is not being pressed by a user) as shown in FIGS. 6A and 6B. The optical barrier 652 may define an aperture 654 and/or other light-transparent portion that may be moved into alignment with the optical signal emitter 662 and the optical receiver 664 when the optical key switch 650 is actuated (e.g., the optical key switch 650 is depressed by a user) to allow light from the optical signal emitter 662 to be detected by the optical receiver 664. For example, the actuation of the optical key switch 650 may force the optical barrier 652 and aperture 654 downward into alignment with the optical signal emitter 662 and the optical receiver 664 to enable light from the optical signal emitter 662 to pass through the aperture 654 to the optical receiver 664 as shown in FIGS. 6C and 6D. Upon detecting light from the optical signal emitter 662 (which may be a particular frequency that is detectable by the optical receiver 664), the optical receiver 664 may transmit a signal via one or more traces to the processing unit of the keyboard or other peripheral device that the optical key switch 650 has been activated or closed. Once an actuation force is removed from the optical key switch 650, the optical barrier 652 may rebound to the neutral position in which the aperture 654 is out of alignment with the optical signal emitter 662 and the optical receiver 664 to again block light from the optical signal emitter 662 from reaching the optical receiver 664. To facilitate such operation, the optical signal emitter 662 and the optical receiver 664 may be arranged on opposing sides of an aperture formed through the printed membrane 601 and/or mechanical support layer 612.

Each optical key switch 650 may be coupled with the assembly in a number of ways. For example, a portion of the optical barrier 652 may be mounted on the mechanical support layer 612. In such embodiments, the optical barrier 652 may include a fixed portion and a translatable portion (which may include aperture 654) that are slidingly coupled with one another. The fixed portion may be fixedly mounted with the mechanical support layer 612 while permitting the translatable portion to move up and down relative to the fixed portion to enable the aperture 654 to be aligned with the optical emitter 662 from reaching the optical receiver 664 when the optical key switch 650 is depressed. In another embodiment, each optical key switch 650 may include a separate post and/or other support member that may extend through an aperture and/or recess formed in the printed membrane 601 and/or mechanical support layer 612 and be mechanically coupled with the mechanical support layer 612. In some embodiments, rather than, or in addition to, being mechanically coupled with the mechanical support layer 612, each optical key switch 650 may be mechanically coupled with an outer top case 680 or housing of the keyboard or other peripheral. For example, the outer top case 680 may form a top portion of the peripheral device that is visible to users when the peripheral device is assembled. For a keyboard, the outer top case 680 may be a substrate above which the key caps of each key are disposed. Each optical key switch 650 may be coupled with a top and/or bottom surface of the outer top case 680 in some embodiments. For example, each optical key switch 650 may be snap-fit, adhered, fastened, and/or otherwise coupled within an aperture defined through the outer top case 680.

By mechanically coupling the optical key switches 650 to the outer top case 680 and/or the mechanical support layer 612, and by physically uncoupling the optical key switches 650 from the optical emitter 662 and optical receiver 664 (which are physically coupled with a printed membrane 601), embodiments of keyboards (or other peripheral devices) utilizing optical key switches 650 may provide more robust devices. In particular, the lack of moving force applied to the printed membrane 601 during device use results in less wear and tear on the physical connection between the printed membrane 601, mechanical support layer 612, and/or any components mounted on the printed membrane 601. Special care may be taken to ensure flatness of the printed membrane 601, such as by means of more metal studs from top metal to mechanical support, and pre-heat to avoid deformation, and/or by using other methods.

As noted above, the assembly may include a number of LEDs 670 (such as RGB LEDs) and/or other lighting elements. Each LED 670 may be mechanically and electrically coupled with one or more traces of a printed membrane 601. For example, each LED 670 may be soldered (e.g., using low-melt soldering techniques), conductively adhered, and/or otherwise physically coupled with the printed membrane 601. When physically coupled using conductive materials, the LEDs 670 may also be coupled with one or more traces that may supply power and/or communicate other signals between one or more processing units of the peripheral device and the LED 670. As illustrated, the LEDs 670 are disposed either between the two printed membranes 601a (e.g., as shown in FIGS. 6A and 6C) or between printed membrane 601b and mechanical support layer 612 (e.g., as shown in FIGS. 6B and 6D), although other configurations are possible. For example, one or more vias and/or jumpers may be used to enable the LEDs 670 to be positioned on a same surface of a printed membrane 601 as the optical assemblies 660. In embodiments in which the LEDs 670 are disposed between the two printed membranes 601a, a hole may be drilled or otherwise formed in an upper membrane at each LED position that clearance for the body of each LED 670 to protrude through the hole to increase the light efficiency of light projected from the LED 670.

Although not shown here, the assembly may include a ground plane that may encapsulate one or more of the printed membranes 601 between the ground plane and a top outer case or housing of the keyboard or other peripheral device. For example, the ground plane may be positioned on an opposite side of one or more of the printed membranes 601 and the top outer case 680. In some embodiments, the ground plane may be formed as a conductive mesh material. The ground plane may be fabricated using additive manufacturing techniques in some embodiments to further improve the sustainability of the peripheral device. In some embodiments, the ground plane may be formed by printing a conductive mesh pattern on a membrane layer of a printed membrane 601 using a conductive ink (similar to the traces). In such embodiments, the ground plane may be included on one of the printed membranes 601 and/or on another printed membrane, such as a printed membrane that is dedicated to the ground plane. In some embodiments, the ground plane may be coupled with the optical receivers 662 to provide a substantially homogenous return current. For example, one or more vias may be formed through one or more of the printed membranes 601 to electrically couple the optical receivers 662 with the ground plane.

It will be appreciated that the electronics assembly configuration described above is merely provided as one example of an electronics assembly for coupling one or more electrical components to one or more processing units of a peripheral device and that numerous variations may exist. For example, the LED circuitry printed membrane may be omitted and/or additional layers with various functionality may be included. For example, one or more printed membranes with traces for dials, speakers, microphones, biometric readers, and/or other features of the keyboard or other peripheral device may be included. Such traces may be provided on a same or different face of an existing printed membrane 601 and/or one or more sets of traces may be provided on a separate printed membrane.

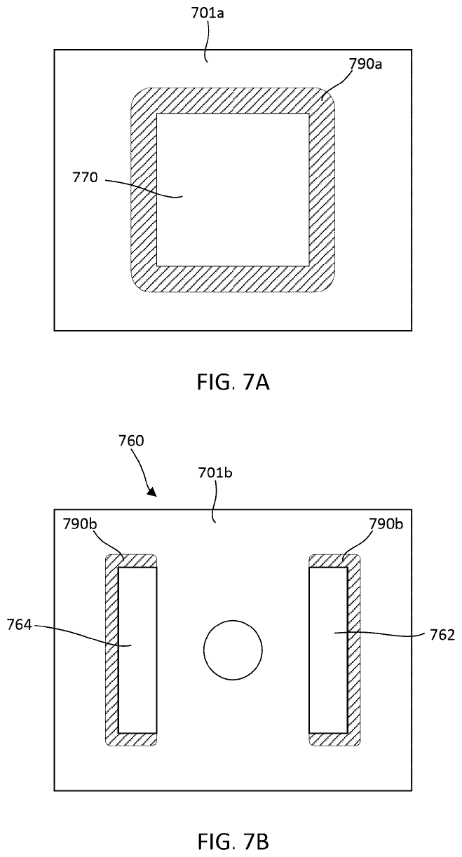

As noted above, certain materials (e.g., polymers such as PET) that may be used for the membrane layer of the printed membranes 601 may have low melting points that may make it difficult to utilize conventional soldering techniques to electrically couple the electrical components (such as optical emitter 662, optical receivers 664, and/or LEDs 670) with traces on the printed membrane 601 without risking damage to the membrane layer. Therefore, some embodiments may use low temperature joining techniques, such as low-melt solder (e.g., solder compositions having melting points lower than a melting point of the membrane layer), conductive adhesives, and/or other electrical joining techniques. In some embodiments, the use of a bonding agent (e.g., adhesive and/or solder) may be utilized to ensure robustness of the components assembly, and custom bonding agent patterns may be used that do not interfere with the performance of the electrical components. For example, as illustrated in FIGS. 7A and 7B, different components may have different bonding patterns. FIG. 7A illustrates an LED 770 that is bonded to a printed membrane 701a. Rather than applying a bonding agent over a top of the LED 770 as done conventionally, a bonding agent 790a is applied about all or a portion of a periphery of the LED 770 such that a light-emitting surface of the LED 770 is not obscured by and/or otherwise covered by the bonding agent 790a. As illustrated, the LED 770 has a generally rectangular periphery, which results in the bonding agent 790a being applied in a generally rectangular shape. Other shapes (circles, triangles, stars, etc.) of LEDs 770 and/or bonding agent 790a are possible. Additionally, while shown as a solid perimeter of bonding agent 790a, it will be appreciated that the bonding agent 790a may be applied in two or more disconnected segments about the periphery of the LED 770. FIG. 7B illustrates an optical assembly 760 that is bonded to a printed membrane 701b. The optical assembly 760 may include an optical signal emitter 762 and an optical receiver 764. A bonding agent 790b may be applied about one or more of the sides of the optical signal emitter 762 and optical receiver 764 that do not face one another. For example, the center-facing sides of each of the optical signal emitter 762 and optical receiver 764 may be free of the bonding agent 790b to ensure that the bonding agent 790b does not obstruct light emitted from the optical signal emitter 762 from reaching the optical receiver 764. In some embodiments, this may result in a generally U-shaped pattern of bonding agent 790b, although other shapes, such as L-shapes, single linear patterns, two parallel lines, and/or other patterns of bonding agent 790b may be utilized in various embodiments.

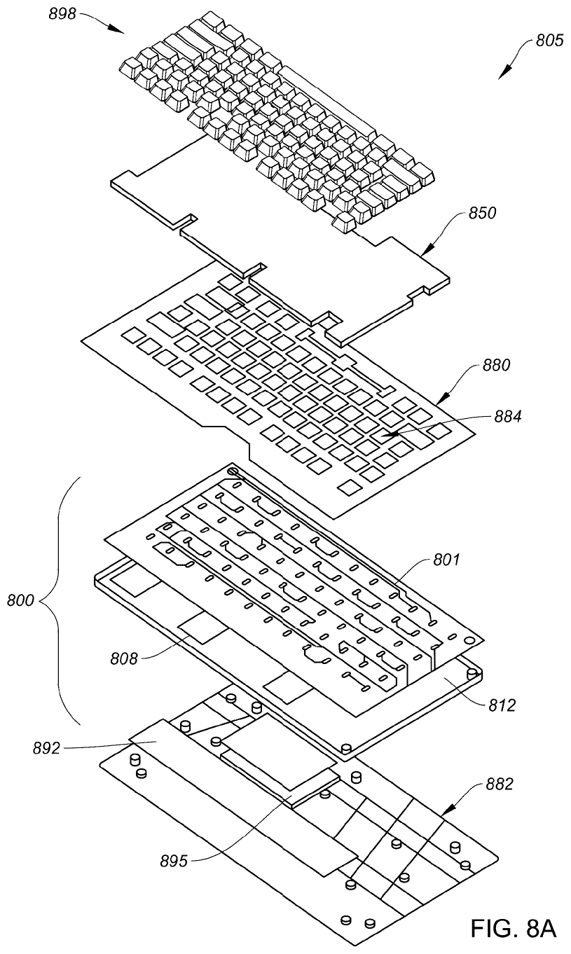

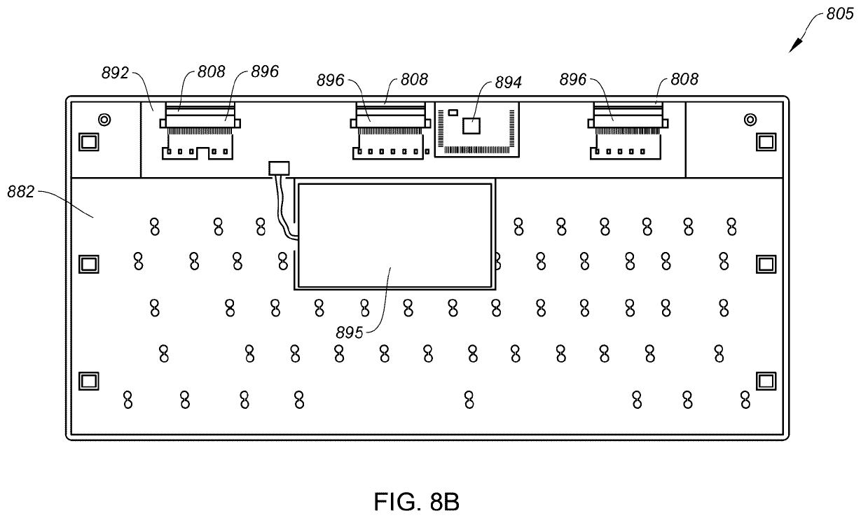

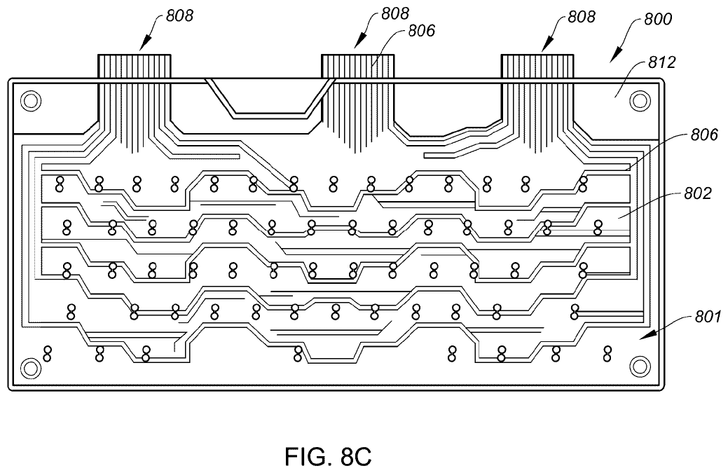

FIGS. 8A-8C illustrate one embodiment of a keyboard 805 that includes at least one printed membrane stack 800, which may be similar to and include any of the features described in relation to printed membrane stacks 100, 300, 400, and/or 600. Keyboard 805 may include an outer bottom case 882 that may form a bottom surface of a housing of the keyboard 805 and an outer top case 880 that may form a top surface of the housing of the keyboard 805. When coupled together, the outer top case 880 and outer bottom case 882 may define an open interior that may house the internal components of the keyboard 805, including the printed membrane stack 800. In some embodiments, a main printed circuit board assembly (PCBA) 892 and/or battery 895 may be disposed within the open interior defined by the outer top case 880 and outer bottom case 882. For example, as best illustrated in FIG. 8B, the main PCBA 892 and/or battery 895 may be mounted to the outer bottom case 882, such as by using one or more fasteners, snap-fit features, adhesives, and/or other coupling techniques. The main PCBA 892 may provide a mounting substrate for one or more integrated circuits 894 or other processing units of the keyboard 805, such as a microcontroller for receiving key press signals (e.g., signals transmitted from traces associated with each key switch when a given key switch is depressed and/or when a circuit associated with a given switch is closed) and transmitting signals to an attached computing device (e.g., mobile phone, personal computer, tablet computer, e-reader, etc.), an LED driver, and/or other processing unit. The main PCBA 892 may also include one or more connectors 896 that may each receive and couple with one or more fingers 808 of a printed membrane 801 (which may be similar to and include any of the features described in relation to printed membranes 101, 201, 301, 401, 601, and/or 701) of the printed membrane stack 800. For example, the fingers 808 may extend beyond a boundary of a mechanical support layer 812 of the printed membrane stack 800 and may be folded and/or otherwise inserted into engagement with the connectors 896. This may electrically couple the traces on the fingers 808 with the main PCBA 892 and the integrated circuits 894. In some embodiments, the main PCBA 892 may include circuitry and/or electrical components (such as filters) that may help regulate signal levels to be at a particular level despite the resistance of the conductive ink of the traces. Additionally, the circuitry may filter possible electrostatic discharge that may be caused in the event that no ground plane is present on a membrane layer of the printed membrane 801. Main PCBA 892 may include additional features, such as wireless chips (e.g., Bluetooth), universal serial bus (USB) connectors, on/off connectors and/or switches, and/or other components. The battery 895 (or other power source) may be coupled with the main PCBA 892. In some embodiments, the main PCB may be eliminated. In such embodiments, the processing units and/or connectors may be mounted on one or more membranes.

In some embodiments, the main PCBA 892 and/or battery 895 may be disposed below the printed membrane stack 801 (e.g., between the printed membrane stack 801 and the outer bottom case 882) although other relative positions of the components are possible in various embodiments. The outer top case 880 may be positioned above the printed membrane stack 801 to sandwich the printed membrane stack 801, main PCBA 892, battery 895, and/or other internal components between the outer top case 880 and outer bottom case 882. As illustrated, optical key switches 850 may be coupled atop the outer top case 880, such as being inserted through apertures 884 formed through the outer top case 880 at each key location of the keyboard 805. In other embodiments, the key switches may be positioned underneath the outer top case 880. For example, when the key switches are mechanical key switches, the key switches may be mechanically coupled with a membrane layer and mechanical support layer 812 of the printed membrane stack 800. Key caps 898 may be fitted over the key switches.

FIG. 8C illustrates the printed membrane 801 of the printed membrane stack 800 disposed on the mechanical support layer 812. A number of fingers 808 extend beyond the lateral boundaries of the mechanical support layer 812, which may enable the fingers 808 to be folded and/or otherwise maneuvered into engagement with the connectors 896 of the main PCBA 892. Collectively, the fingers 808 include one end of each trace 806 printed on the membrane layer 802 of the printed membrane 801. The use of multiple fingers 808 may reduce the number of traces 806 on each finger 808, which may help reduce the trace density in a north-south direction (as illustrated) proximate the fingers 808. This may help reduce the footprint of the printed membrane stack 800 and prevent the need to enlarge the housing of the keyboard 805. While shown with three fingers 808, it will be appreciated that any number of fingers 808 may be present in various embodiments. For example, the printed membrane 801 may include at least one finger 808, at least two fingers 808, at least three fingers 808, at least four fingers 808, at least five fingers 808, or more. In some embodiments, to prevent voltage drop through the traces 806 that may occur due to the resistance of the conductive material in the ink, traces 806 that require the highest current levels may be routed on areas of the membrane layer 802 that include the most unused area. This may enable such traces 806 to be enlarged to support the higher current levels.

It will be appreciated that keyboard 805 is merely provided as an example and that other keyboard configurations that include one or more printed membrane stacks 800 are possible. As just one example, while not explicitly shown, keyboard 805 may include a ground plane that may be positioned between the printed membrane stack 800 (or a portion thereof) and the outer bottom case 882 such that at least a portion of the printed membrane stack 800 is disposed between the outer top case 880 and the ground plane. The ground plane may be a completely separate component and/or may form a portion of the printed membrane stack 800. For example, one or more membrane layers of the printed membrane stack 800 may include a ground plane printed thereon, such as in the form of a conductive mesh.

It should be noted that the systems and devices discussed above are intended merely to be examples. It must be stressed that various embodiments may omit, substitute, or add various procedures or components as appropriate. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known structures and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or ±0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or ±0.1% from the specified value, as such variations are appropriate to in the context of the systems, devices, circuits, methods, and other implementations described herein.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

What is claimed is:

1. An electronics assembly of a computer peripheral device, comprising:
an outer top case;
a mechanical support layer disposed on an inner side of the outer top case;
a membrane layer coupled with the mechanical support layer, the membrane layer comprising a printed trace on at least one surface of the membrane layer; and
a ground plane positioned on an opposite side of the membrane layer as the outer top case such that the mechanical support layer and the membrane layer are disposed between the outer top case and the ground plane.

2. The electronics assembly of a computer peripheral device of claim 1, wherein:
the ground plane comprises a conductive mesh.

3. The electronics assembly of a computer peripheral device of claim 2, wherein:
the conductive mesh is printed on the membrane layer on an opposite side of the printed trace.

4. The electronics assembly of a computer peripheral device of claim 1, wherein:
the membrane layer comprises one or more vias that extend through a thickness of the membrane layer to electrically couple the ground plane and the printed trace.

5. The electronics assembly of a computer peripheral device of claim 1, further comprising:
an additional membrane layer that is coupled with the mechanical support layer, the additional membrane layer comprising an additional printed trace on at least one surface of the additional membrane layer.

6. The electronics assembly of a computer peripheral device of claim 1, further comprising:
an ultraviolet ink insulation layer disposed atop the printed trace.

7. The electronics assembly of a electronics assembly of a computer peripheral device of claim 6, further comprising:
at least one jumper that extends over the ultraviolet ink insulation layer.

8. The electronics assembly of a computer peripheral device of claim 1, further comprising:
a keyboard switch that extends through the membrane layer and the mechanical support layer.

9. An electronics assembly of a computer peripheral device, comprising:
an outer top case;
a mechanical support layer;
a first membrane layer coupled with the mechanical support layer, the first membrane layer comprising a first trace that is printed on at least one surface of the first membrane layer;
a second membrane layer coupled with the mechanical support layer, the second membrane layer comprising a second trace that is printed on at least one surface of the second membrane layer; and
a ground plane positioned on an opposite side of the first and second membrane layers as the outer top case such that the mechanical support layer, the first membrane layer, and the second membrane layer are disposed between the outer top case and the ground plane.

10. The electronics assembly of a computer peripheral device of claim 9, further comprising:
an additional ground plane positioned between the first and second membrane layers and the outer top case.

11. The electronics assembly of a computer peripheral device of claim 9, wherein:
the ground plane is printed on one of the first and second membrane layers.

12. The electronics assembly of a computer peripheral device of claim 9, wherein:
the ground plane is printed on a third membrane layer.

13. The electronics assembly of a computer peripheral device of claim 9, wherein:
the first membrane layer comprises one or both of polyethylene terephthalate and a polyamide.

14. The electronics assembly of a computer peripheral device of claim 9, wherein:
the first and second traces are printed using conductive ink that comprises at least one material selected from the group consisting of silver, carbon, and copper.

15. An electronics assembly of a computer peripheral device, comprising:
an outer top case;
a mechanical support layer;
a membrane layer coupled with the mechanical support layer, the membrane layer comprising a printed circuit on at least one surface of the membrane layer, the printed circuit comprising a keyboard matrix;
a ground plane positioned on an opposite side of the membrane layer as the outer top case such that the mechanical support layer and the membrane layer are disposed between the outer top case and the ground plane; and
a plurality of switches that each extend through the membrane layer and the mechanical support layer.

16. The electronics assembly of a computer peripheral device of claim 15, wherein:
each of the plurality of switches comprises an optical key switch; and
the computer peripheral device further comprises a plurality of optical sensor assemblies, with an optical sensor assembly of the plurality of optical sensor assemblies being disposed on the membrane layer proximate each of the plurality of plurality of switches.

17. The electronics assembly of a computer peripheral device of claim 16, wherein:
each optical assembly comprises an infrared emitter and a phototransistor.

18. The electronics assembly of a computer peripheral device of claim 17, wherein:
the ground plane comprises a conductive mesh that is printed on the membrane layer on an opposite side of the printed circuit;
the membrane layer comprises a plurality of vias that extend through a thickness of the membrane layer to electrically couple the ground plane and the printed circuit; and
a respective one of the vias electrically couples each phototransistor with the ground plane.

19. The electronics assembly of a computer peripheral device of claim 16, wherein:
each optical key switch is mounted on the outer top case.

20. The electronics assembly of a computer peripheral device of claim 15, further comprising:
a plurality of RGB diodes that are coupled with the membrane layer.
